(19) United States
(12) Patent Application Publication
(10) Pub. No.: US 2007/0202261 A1
(43) Pub. Date: Aug. 30, 2007

(54) Ink-jet recording head producing method

(76) Inventor: Takehiro Matsushita, Tokyo (JP)

Correspondence Address: CANTOR COLBURN, LLP, 55 GRIFFIN ROAD SOUTH, BLOOMFIELD, CT, 06002, US

(21) Appl. No.: 11/709,443

(22) Filed: Feb. 22, 2007

(30) Foreign Application Priority Data
Feb. 27, 2006 (JP) JP2006-049910

(51) Int. Cl. B05D 3/02

(52) U.S. Cl. 427/372.2

(57) ABSTRACT

A method of producing an ink-jet recording head, comprises steps of: coating a coating liquid containing an aqueous dispersion of a fluororesin and water-soluble polyamidoimide onto at least an ink jetting surface of the ink-jet recording head; and thereafter, conducting a heat treatment onto the coating layer formed on the ink jetting surface so that an ink repelling layer is formed on the ink jetting surface.

This application is based on Japanese Patent Application No. 2006-049910 filed on Feb. 27, 2006, in Japanese Patent Office, the entire content of which is hereby incorporated by reference.

### BACKGROUND OF THE INVENTION

The present invention relates to an ink-jet recording head producing method.

Regarding an ink-jet recording head for recording an image by jetting fine droplets of ink, straightness of the flying course of ink droplets is strongly required for realizing the high quality image recording. When the ink adheres around the jetting nozzle, the course of the ink jetted from the nozzle is deviated so that the straightness of the flying course of the ink droplets is lowered. Therefore, it is carried out to give ink repelling ability onto the ink jetting surface of nozzle plate as the ink jetting surface by forming an ink-repellent layer so that the ink does not adhere around the jetting opening and the straightness of the ink flying course can be kept on the occasion of the jetting. Tough a layer of fluororesin excellent in the water repelling ability is usable as the water repelling layer, the adhesiveness of such the fluororesin to the substrate material is low since the surface energy of the resin is low. When the adhesiveness with the substrate is low, the water repelling layer tends to be peeled off so that the stable jetting is hardly kept and the durability of the head is lowered.

Consequently, methods for improving the adhesiveness of the fluororesin layer with the substrate material have been proposed.

In Tokkai Sho (Japanese Patent Unexamined Publication No.) 63-126758, for example, a method is proposed in which a top coat composition of an aqueous dispersion of a tetrafluoroethylene/hexafluoropropylene copolymer is coated and baked on a primer layer formed by coating and drying at least one of a polyamide acid solution and a polyimide solution on the nozzle surface formed by a light-sensitive glass.

In Tokkai Hei 6-264000, it is proposed to form the primer layer by a coating composition containing a polyester sulfone, a polyamidoimide and/or a polyimide, fluororesin and a metal powder.

In Tokkai Sho 53-74532, a coating composition is proposed, which is composed of at least three components of a poly(allylene sulfide) resin, a polyamidoimide resin and/or a polyimide resin and a fluororesin.

There is a problem in the methods such as those described in Patent documents 1 and 2 that the cost is raised by increasing the processes because the forming process of the ink-repellent layer is composed of two processes of the primer layer coating process and the top-coat layer forming process.

Moreover, the aqueous coating liquid containing the polyamidoimide resin is usually an ununiform system such as that described in Patent Document 3. For example, when the ununiform system coating liquid is used, unevenness of the coated layer tends to be formed and a problem of the fluctuation of the ink jetting ability is caused when such the method is applied for the ink-jet recording head.

### SUMMARY OF THE INVENTION

An object of the invention is to provide a producing method of producing an ink-jet recording head which has high durability and stable ink jetting ability and is capable of forming high quality images by dissolving the above problems caused by the usual technique for giving the water repelling ability to the ink jetting surface.

In order to attain the above object, the present invention forms a fluororesin coating layer excellent in adhesiveness with a single coating process by using water-soluble polyamidoimide.

Concretely, the above object can be attained by the following methods.

1. A producing method of producing an ink-jet recording head, comprises: steps of:

coating a coating liquid containing an aqueous dispersion of a fluororesin and water-soluble polyamidoimide onto at least an ink jetting surface of the ink-jet recording head; and thereafter

conducting a heat treatment onto the coating layer formed on the ink jetting surface so that an ink repelling layer is formed on the ink jetting surface.

2. In the producing method of claim 1, the heat treatment is conducted under a temperature within a range of from 300° C. to 400° C.

3. In the producing method of claim 1, the fluororesin includes tetrafluoroethylene-hexafluoropropylene copolymer.

4. In the producing method of claim 1, the coating liquid contains polyoxyethylene alkyl ether.

5. In the producing method of claim 1, the producing method further comprises a step of:

activating the ink jetting surface before the step of coating the coating liquid onto the ink jetting surface.

6. In the producing method of claim 1, the ink jetting surface is formed on an nozzle forming member.

7. In the producing method of claim 1, the water-soluble polyamidoimide is prepares in such a way that polyamidoimide is dissolved in a basic polar solution, a basic compound is mixed in the basic polar solution, and then water is added in the mixed basic polar solution.

In the invention, the ink-repellent layer having high uniformity and adhesiveness can be formed on the nozzle surface by a simple and short time treatment, namely by one coating process, since the ink-repellent layer is formed on the ink jetting surface by coating a coating liquid containing an aqueous dispersion of fluororesin and a water-soluble polyamidoimide. Accordingly, an ink-jet recording head having high durability and stable ink jetting ability can be produced with low cost by the invention.

### BRIEF DESCRIPTION OF THE DRAWINGS

FIG. 1 shows an oblique view of an example of ink-jet recording head.

FIG. 2 shows a cross section of an example of ink-jet recording head.

### DETAILED DESCRIPTION OF THE PREFERRED EMBODIMENT

The invention is described by embodiments thereof but the invention is not limited to the described embodiments.

A fluororesin is used as the material for forming the ink-repellent layer and the coating liquid of the invention contains an aqueous dispersion of the fluororesin.

As the fluororesin, polytetrafluoroethylene (PTFE), tetrafluoroethylene-perfluoroalkyl vinyl ether copolymer (PFA), tetrafluoroethylene-hexafluoropropylene copolymer (FEP), tetrafluoroethylene-ethylene copolymer (ETFE), polychlorotrifluoroethylene (PCTFE) and poly(vinylidene fluoride) (PVDF) are usable and EFP is preferable because which is low in critical surface tension, excellent in the ink repelling ability and low in the viscosity in molten state at a temperature of thermal treatment of from 300 to 400° C. so as to be able to form a uniform layer.

In the invention, water-soluble polyamidoimide (PAI) is used as the material for raising the adhesiveness of the ink-repellent layer with the nozzle surface. PAI is represented by the following Formula 1.

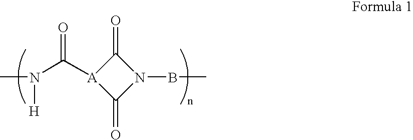

In the above formula, A and B are each an organic group.

PAI is usually not dissolved in water. In the invention, therefore, water-soluble PAI is obtained by mixing and stirring PAI with a basic compound such as an amine compound in a basic polar solution and gradually adding water.

As a result of further investigation, it is found that the adhesiveness of the repelling layer with the substrate can be improved without lowering in the ink repelling ability of the layer and the durability of the ink-repellent layer can be further raised by adding a surfactant to the coating liquid.

The durability of the ink-repellent layer can be further raised by using polyoxyethylene alkyl ether as the surfactant.

The polyoxyethylene alkyl ether is represented by the following Formula 2.

RO—CH₂—CH₂ₙOH Formula 2

In the above, R is a long chain alkyl group having 6 or more carbon atoms, which may have an aromatic ring. The compound in which n is about 10 to 30 is preferable.

Spray coating, spin coating, brush coating, dip coating or wire bar coating can be applied as a method for forming the ink-repellent layer. In the invention, the layer having high adhesiveness can be formed by once coating and the coating can be carried out with high efficiency.

The coated layer is treated by heating after the coating and drying. The treating temperature is preferably a temperature of from 300° C. to 400° C.

Long time is necessary for ink-repellent layer forming process and the layer having high adhesiveness is hardly formed by the method in which the primary layer is formed and then the ink-repelling layer is formed on the primer layer. In such the case, adhesiveness of the fluororesin layer is relatively low since there is an interface between the primer layer and the fluororesin layer.

When the uniform system coating liquid containing water-soluble PAI such as that in the invention is used, it is considered that the adhesiveness is further raised because any interface is not formed in the layer even though PAI having relatively high combining force with the substrate is localized near the surface of the substrate and the fluororesin is localized near the layer surface.

The invention has environmental, safety and economical merits since the aqueous coating liquid is used.

The surface of the substrate may be activated previous to the coating for raising the wettability of the nozzle constituting member as the substrate for the coating liquid.

For the activation treatment, treatment by plasma, corona, ozone, UV or excimer laser can be applied.

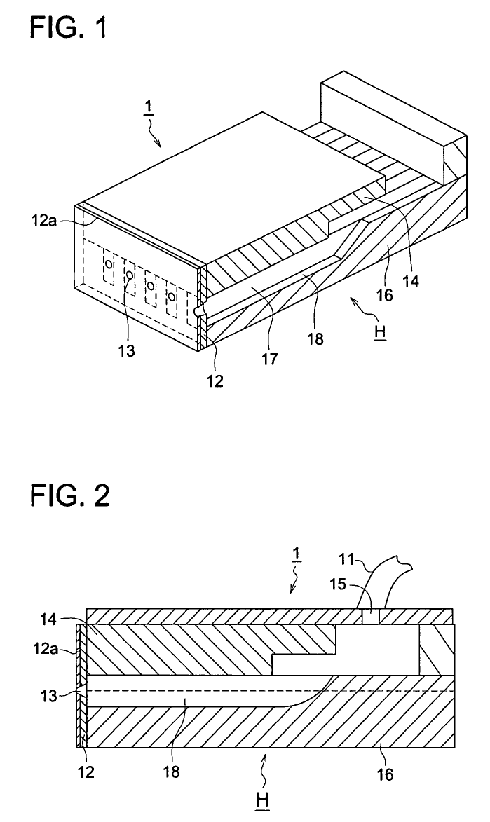

FIGS. 1 and 2 are drawings of an example of the recording head and FIG. 1 shows a schematic oblique view and FIG. 2 shows a cross section. In the drawings, 1 is an ink-jet recording head, 11 is an ink tube, 12 is a nozzle constituting member (nozzle plate), 13 is nozzle, 14 is a cover plate, 15 is an ink supplying opening, 16 is base plate and 17 is a partition. An ink channel 18 is constituted by the partition 17, cover plate 14 and base plate 16.

The ink-jet recording head 1 is a share mode type recording head having plural ink channels are arranged in parallel between the cover plate 14 and the base plate 16. The ink channels 18, a part of them are shown in the drawings, are each separated by partitions 17 which are constituted by a piezo material such as PZT as an electro-mechanical conversing means.

For the nozzle constituting material 12, a material having ink resistivity and high dimensional stability such as ceramics, metal, glass or resin can be used. The glass can be suitably selected from quarts, synthesized quarts and high purity glass, and the resin can be suitably elected from, for example, polyethylene terephthalate (PET), polyethylene naphthalate (PEN), polyimide (PI) and polyphenylene sulfide (PPS). Thickness of the nozzle constituting member 12 is preferably from about 50 μm to 500 μm.

The form of the partition 17 is varied by driving signals so as to vary the volume of the ink channel 18 and the ink is jetted from the nozzle 13 and replenished into the ink channel 18.

The ink-repellent layer 12a is formed on the outer surface of the nozzle constituting member 12, namely on the ink jetting surface.

The ink-repellent layer is formed by usually known coating method as above-mentioned, in which the nozzle 23 is formed by laser irradiation after the formation of the ink-repellent layer 12a or the ink-repellent layer 12a is formed after formation of the nozzle.

The ink-jet recording head 1 is constituted in such a way that the ink channel 18 is formed by the partition 17 and the nozzle constituting member 12 on which the nozzles are formed is jointed with the front face of main body of the head H.

### EXAMPLES

### (1) Example 1

A coating liquid was prepared by adding an aqueous dispersion of FEP and water-soluble PAI into water.

Solid content of the FEP dispersion was 10 weight % and that of the water-soluble PAI was 6 weight %. ND-1 manufactured by Daikin Kogyo Co., Ltd., was used as the aqueous dispersion of FEP and HPC-1000 manufactured by Hitachi Kasei Kogyo Co., Ltd., was used as the water-soluble PAI.

### (2) Example 2

A coating liquid was prepared by adding polyethylene glycol monododecyl ether to the coating liquid prepared in Example 1. The content of polyethylene glycol monododecyl ether was 10 weight %.

### (3) Example 3

A coating liquid was prepared by adding an aqueous dispersion of FEP and water-soluble PAI into water. ND-1 manufactured by Daikin Kogyo Co., Ltd., was used as the aqueous dispersion of FEP and a solid content of the FEP dispersion was 20 weight %. Further, the water-soluble PAI was synthesized in such a way that N-methyl amino ethanol in the amount of 0.2 g was mixed in a solution in which 2 g of PAI resin was dissolved in 1 g of NMP, water was added drop by drop in the mixture while stirring the mixture at 70° C. so that total 8 g of water was added while maintaining the homogenous, and the stirring was conducted for 1 hors. The solid component of the water soluble PAI used for the coating solution was 30 weight %.

### (4) Comparative Example

A coating liquid was prepared by diluting the aqueous dispersion of FEP by water. The solid content of FEP dispersion was made to 10%.

The coating liquids prepared in Examples 1, 2 and 3 and Comparative example were each coated by a wire bar on a nozzle constituting member (a polyimide plate of 75 μm) so as to form a layer having a thickness of about 50 μm.

Each of the coated layers was subjected to heat treatment at 350° C. for 4 hours to form an ink-repellent layer.

Each of the surface of samples on which the ink-repellent layer was formed by the above procedure was rubbed for 100 times by non-woven cloth and the receding contact angle of the surface was measured before and after the rubbing with Contact angle meter CA-X produced by Kyowa Interface Science Co., Ltd.

The receding contact angle was measured by using the following Inks 1, 2 or 3.

Ink 1

| | | |
|---|---|---|
| Dispersion dye (C.I. Disperse Yellow) | 5% | by weight |
| Disperser Demol C (Kao Co., Ltd.) | 0.5% | by weight |
| Glycerol | 20% | by weight |
| Urea | 3% | by weight |
| Deionized water | 71.5% | by weight |

Ink 2

| | | |
|---|---|---|
| Dispersion dye (C.I. Disperse Yellow) | 2% | by weight |
| Binder resin (Styrene-acryl copolymer) | 5% | by weight |
| Diethylene glycol diethyl ether | 88% | by weight |
| N-pyrrolidone | 5% | by weight |

Ink 3

| | | |
|---|---|---|
| Dispersion pigment (carbon black) | 5% | by weight |
| Saturated hydrocarbon type solvent having liner or | 95% | by weight |
| branched structure principally containing 15 to 19 | | |
| carbon atoms | | |

Results of the measurement are shown in Table 1.

TABLE 1

| | | | | Receding | | Receding |
|---|---|---|---|---|---|---|
| | | Receding | | contact | | contact |
| | | contact | | angle | | angle |
| | Ink 1 | angle | Ink 2 | (After | Ink 3 | (After |
| | Receding | (After | Receding | rubbing | Receding | rubbing |
| | contact | rubbing for | contact | for 100 | contact | for 100 |
| | angle | 100 times) | angle | times) | angle | times) |
| Example 1 | 57° | 18° | 46° | 20° | 37° | 12° |
| Example 2 | 55° | 34° | 48° | 42° | 36° | 29° |
| Example 3 | 53° | 48° | 49° | 52° | 37° | 27° |
| Comparative | 48° | 2° | 42° | 3° | 26° | 2° |
| example | | | | | | |

In the ink-jet recording head, wetting on the ink jetting surface by remaining ink largely influences to the ink jetting ability and causes problems. Therefore, large receding contact angle is important. It is understood, as shown in Table 1, that the receding contact angles after rubbing of 100 times of Examples 1, 2 and 3 are larger than that in Comparative example and suitable ink-repelling ability is maintained after the rubbing.

Particularly, the receding contact angle to Ink 3 is not lowered and the ink-repelling ability is maintained after the rubbing in Example 2 and 3.

As above-described, the ink-jet recording head having the ink-repellent layer of the invention on the ink jetting face thereof can be held good ink jetting property for long time and the ink-jet recording head having high durability can be provided by the invention.

What is claimed is:

1. A method of producing an ink-jet recording head, comprising: steps of:
coating a coating liquid containing an aqueous dispersion of a fluororesin and water-soluble polyamidoimide onto at least an ink jetting surface of the ink-jet recording head; and thereafter
conducting a heat treatment onto the coating layer formed on the ink jetting surface so that an ink repelling layer is formed on the ink jetting surface.

2. The method of claim 1, wherein the heat treatment is conducted under a temperature within a range of from 300° C. to 400° C.

3. The method of claim 1, wherein the fluororesin includes tetrafluoroethylene-hexafluoropropylene copolymer.

4. The method of claim 1, wherein the coating liquid contains polyoxyethylene alkyl ether.

5. The method of claim 1, further comprising a step of:
activating the ink jetting surface before the step of coating the coating liquid onto the ink jetting surface.

6. The method of claim 1, wherein the ink jetting surface is formed on an nozzle constituting member.

7. The method of claim 1, wherein the water-soluble polyamidoimide is prepared in such a way that polyamidoimide is dissolved in a basic polar solution, a basic compound is mixed in the basic polar solution, and then water is added in the mixed basic polar solution.
